(19) United States
(12) Patent Application Publication
(10) Pub. No.: US 2011/0122031 A1
(43) Pub. Date: May 26, 2011

(54) Radio Device for a Wireless Network

(76) Inventors: Luca Di Donato, Ostia Lido (IT); Andrea Kropp, Roma (IT); Claudio Malavenda, Roma (IT); Claudio Marchesini, Roma (IT); Sandro Mattiacci, Roma (IT); Stefano Romani, Roma (IT)

(21) Appl. No.: 12/867,198

(22) PCT Filed: Feb. 13, 2008
(86) PCT No.: PCT/IT2008/000088

§ 371 Date: Dec. 14, 2010

(51) Int. Cl. H01Q 3/24; H01Q 1/24

(52) U.S. Cl. 343/702

(57) ABSTRACT

A radio device for a wireless network comprising: an outer protective casing housing an electronic transceiver circuit; and four radiating elements carried by the protective casing and having orientations that differ from one another. The outer protective casing is configured in such a way that, when it is set on a plane surface, it sets itself with just one radiating element substantially perpendicular to the plane surface; the radio device is able to determine autonomously the orientation assumed and comprises an automatic selector for selecting the radiating element set substantially perpendicular to the plane surface.

### TECHNICAL FIELD

The present invention relates to a radio device for a wireless network.

### DISCLOSURE OF INVENTION

In particular, the aim of the present invention is to provide a device that is able to maximize the properties of reception and transmission of a transceiving apparatus that operates in a node of a network formed by a plurality of devices.

A further aim of the present invention is to provide a radio device for a wireless network that:
presents contained costs;
is extremely robust;
is simple and fast to produce; and
presents low levels of consumption and consequently has a rather long life.

The above aim is achieved by the present invention in so far as it relates to a radio device for a wireless network comprising: an outer protective casing housing an electronic transceiver circuit; and at least one first radiating element and one second radiating element, which are carried by said protective casing and have orientations that differ from one another, said radio device for a wireless network being characterized in that it comprises means for automatic selection of the radiating element that presents a pre-set orientation with respect to a resting surface on which said casing is set.

In particular, the outer protective casing is configured in such a way that, when it is set on a plane resting surface, it sets itself with one radiating element substantially perpendicular to the plane surface. Said automatic-selection means select the radiating element set substantially perpendicular to the plane surface.

### BRIEF DESCRIPTION OF THE DRAWINGS

The invention will now be illustrated with reference to the attached drawings, wherein:

FIG. 1 shows, in perspective view, a radio device for a wireless network obtained according to the teachings of the present invention;

FIG. 2 shows the inside of the device 1;

FIGS. 3 and 4 show, respectively in top plan view and in perspective view, a detail of the device 1;

FIG. 5 shows an example of application of the device according to the present invention; and

FIG. 6 shows, in perspective view, a radio device for a wireless network obtained according to the teachings of the present invention, inserted within a casing of a spherical shape.

### BEST MODE FOR CARRYING OUT THE INVENTION

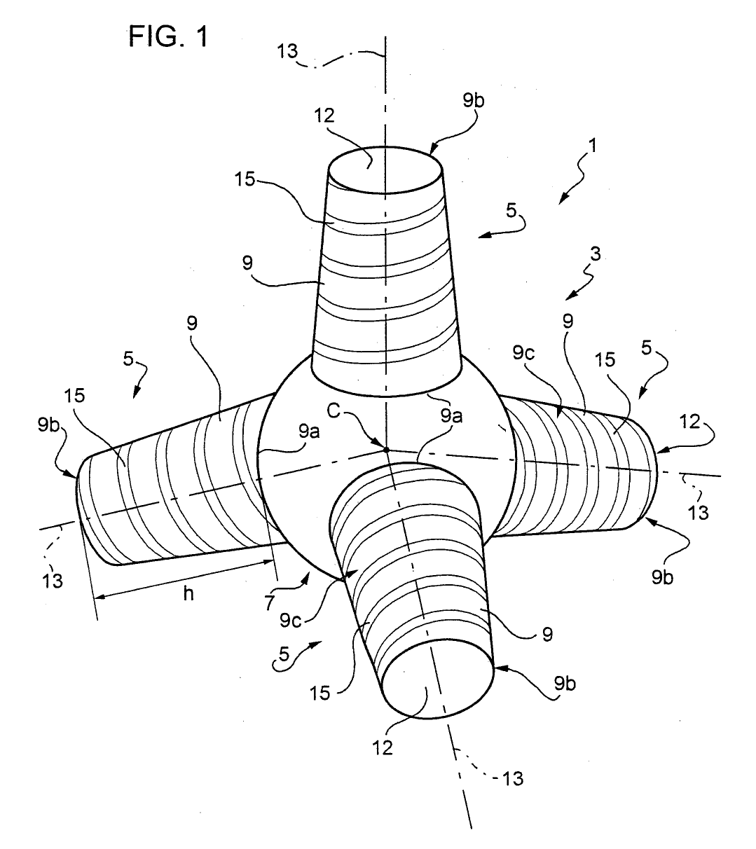

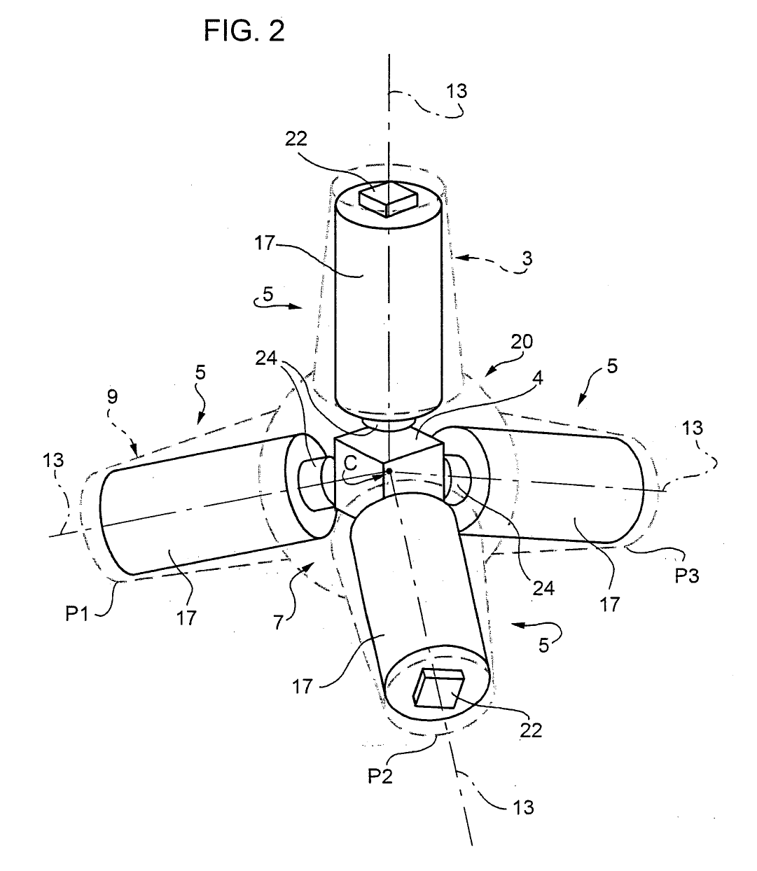

Illustrated as a whole by 1 in FIG. 1 is a radio device for a wireless network comprising:
an outer protective casing 3 housing an electronic transceiver circuit 4 (illustrated in FIG. 2); and
four radiating elements 5 (in the example formed by helical antennas) carried by the protective casing 3 and having geometrical axes of orientation that differ from one another.

As will be clarified in the ensuing description, the protective casing 3 is configured in such a way that, when it is set on a plane resting surface, it sets itself with just one radiating element 5 with its geometrical axis of orientation substantially perpendicular to the plane resting surface itself.

The casing 3 is moreover made of impact-resistant insulating material, for example epoxy resins.

In particular, the protective casing 3 comprises a central portion 7 of spherical shape, and four arms shaped like truncated cones 9, which extend radially from the spherical central portion 7.

Each arm shaped like a truncated cone 9 has an end portion having a larger base 9a and a portion having a smaller base 9b delimited by a plane circular wall 12 perpendicular to an axis of symmetry 13 of the arm shaped like a truncated cone 9.

In other words, each arm shaped like a truncated cone 9 is tapered from the spherical central portion 7 towards its free end portion (plane circular wall 12).

The arms 9 have the same dimensions, in particular the same radial length h (i.e., the same distance between the end portion having a larger base 9a and that having a smaller base 9b measured in a direction parallel to the axis of symmetry 13).

Each arm 9 is associated to a respective radiating element 5 obtained from a metal strip 15 (for example, a copper or aluminium strip) wound in a helix around the outer surface of truncated cone 9c of each arm 9. In this way, each radiating element 5 is obtained from a helical antenna having its axis 13, which coincides with the axis of symmetry of the arm 9.

The axes 13 meet up in a common point C set at the centre of the spherical central portion 7 and form with respect to one another equal angles (of 120°).

Consequently, on the basis of the physical structure illustrated above, the axes of symmetry of the radiating elements 5 and of the arms 9 meet in a common point C set at the centre of the spherical central portion 7 and form with respect to one another equal angles (of 120°).

Each arm 9 is internally hollow and defines a cylindrical cavity sharing the axis 13, which is designed to house a battery 17 (or else a rechargeable battery, FIG. 2) having an elongated cylindrical shape (for example a 1.5-V alkaline battery of the AAA type, FIG. 2) used for supply of the electronic circuit 4.

The aforesaid cylindrical cavity (not illustrated) is also provided with connection means (of a known type, not illustrated) designed to be coupled to the respective poles (+ and −) of each battery 17. Further connection means (of a known type, not illustrated) are designed to connect the batteries 17 to one another to provide a total supply voltage for supply of the electronic circuit 4.

Each battery 17 extends along a respective axis that coincides with the axis 13. The various axes of the batteries 17 thus meet in the point C set at the centre of the spherical portion in such a way that they have a spatial arrangement symmetrical with respect to the centre C of the central portion 7.

The electronic transceiver circuit 4 is housed within the central portion 7 and provides a transceiver unit which is supplied by the batteries 17 and has an antenna terminal (not illustrated) which can be connected to one of the radiating elements 5 through an automatic-selection device 20 designed to provide a connection between the output of the transceiver circuit 4 and the radiating element 5 set perpendicular to a plane on which the device 1 rests. An automatic selection of the radiating element 5 is thus made.

The electronic circuit 4 performs further functions (in addition to the transceiver function) and co-operates with one or more sensors 22 (in the example illustrated, four sensors) each of which is set in a region corresponding of an end portion of an arm 9; in particular, it is set underneath the plane circular wall 12, which can be provided with openings (not illustrated).

Other sensors (not illustrated) can be set in other areas of the device 1, such as, for example, within the central portion 7.

The sensors 22 can comprise, for example:
proximity sensors designed to detect a moving body in the proximity of the device 1;
vibration sensors designed to detect a moving body and/or the passage of a vehicle in the proximity of the device 1;
optical sensors designed to detect an image of the space close to the device 1;
magnetic sensors designed to detect the arrangement and variations of magnetic field in the proximity of the device 1;
microphones;
infrared (IR) sensors; and
MEMS devices.

The automatic-selection device 20 comprises a plurality of switches 24 (four in the example represented, one for each radiating element 5) housed inside the protective casing 3. Each switch 24 is aligned to a respective axis 13 and is set in the proximity of the portion having a larger base 9a of the arm shaped like a truncated cone 9 between the electronic circuit 4 and one end of the battery 17.

As will be clarified in the ensuing description, each switch is configured for switching, by gravity, on the basis of its orientation with respect to the vertical.

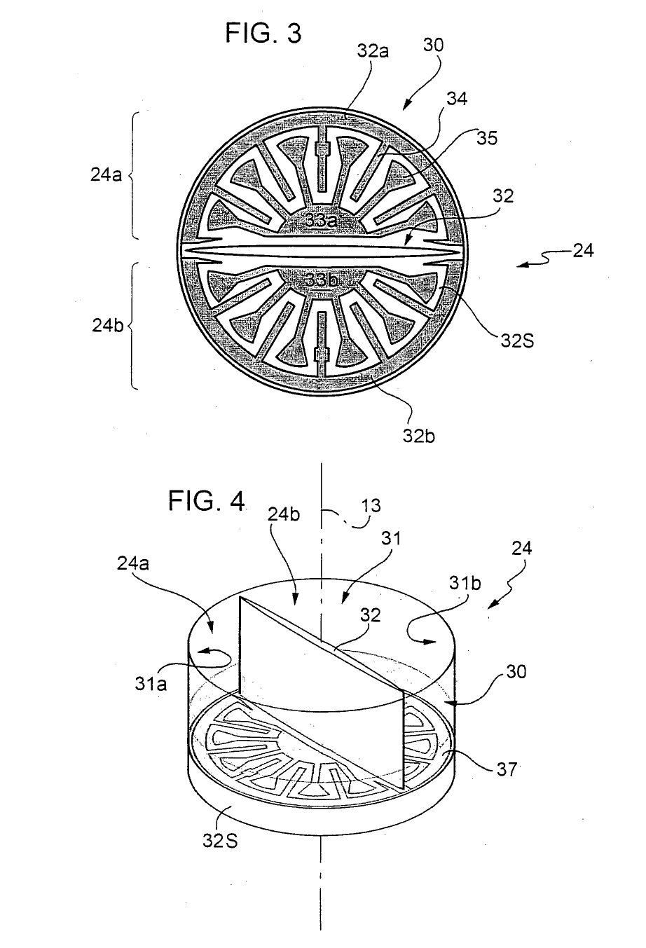

FIGS. 3 and 4 show a possible embodiment of the switch 24.

Said embodiment enables a double switch to be obtained, i.e., a switch comprising a first switch 24a and a second switch 24b which are simultaneously set in the closed state (ON) or else in the open state (OFF) according to the arrangement of the switch 24 with respect to the vertical.

The switch 24 is connected, with respect to the circuit 4, in such a way that, when it is set in the closed position (ON), the circuit 4 is connected to the radiating element 5 having its axis 13 perpendicular to the plane on which the device 1 rests through a first switch 24a, and a sensor 22 is connected to the electronic circuit 4 through a second switch 24b.

More in particular, the switch 24 comprises a cylindrical casing 30, which defines an internal cylindrical cavity 31 delimited at one first end thereof by a circular printed circuit 32 set, in use, perpendicular to the axis 13.

The cylindrical cavity 31 is divided by a diaphragm 32 that extends in a diametral direction inside the chamber 31 so as to define a first chamber 31a and a second chamber 31b that are separate from one another.

The printed circuit 32 has, on its side facing the cavity 31, first C-shaped conductive paths 32a, 32b, which extend along a perimetral portion of the circular printed circuit 32 and face the chamber 31a and the chamber 31b, respectively.

The printed circuit 32 moreover has, on its side facing the cavity 31, second semicircular conductive paths 33a, 33b projecting towards a central portion of the circular printed circuit 32s and facing the chamber 31a and the chamber 31b, respectively.

Moreover provided are radial conductive elements 34, 35 that project, without touching, from the path 32a, 32b and the path 33a, 33b, respectively.

Each chamber 31a, 31b houses a pre-set amount of electroconductive material, for example electroconductive liquid, such as mercury 37 (FIG. 4), which, when the printed circuit 32 is set perpendicular to the vertical (or else parallel to a horizontal plane), covers the paths 32a, 32a and 32b, 33b providing a connection between these (switches 24a, 24b both closed).

When the printed circuit 32 is set inclined with respect to the vertical, the mercury 37 is displaced and interrupts the connection between the paths 32a, 33a and 32b, 33b providing an electrical decoupling between these (switches 24a, 24b open).

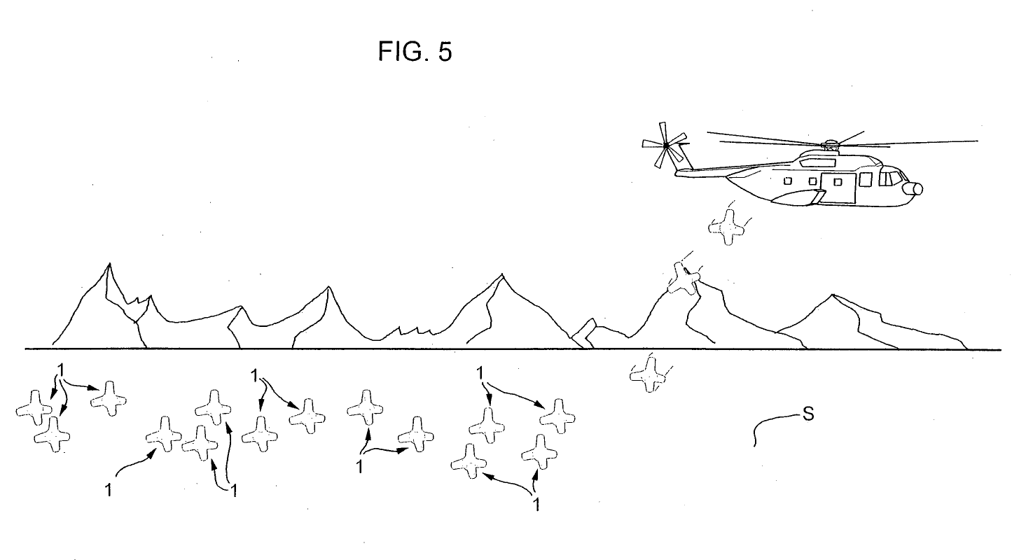

In use, the device 1 is thrown (for example, from a helicopter—FIG. 5) on a portion of territory that is to be surveyed.

The device 1 comes into contact with the ground S and, after possibly bouncing and rolling thereon, sets itself in contact with the ground with three of its arms shaped like truncated cones 9. In this position, the arm not in contact with the ground necessarily sets itself perpendicular to a plane passing through the three points of contact between the ends of the arms shaped like truncated cones 9 and the ground.

In other words, the sensor 1 assumes an orientation such as to leave just one radiating element 5 in a preferential position (i.e., substantially vertical) with respect to the others and such as to see the ground as an infinite ground plane.

In this way (i.e., in the presence of a radiating element 5 perpendicular to the ground), in a device 1 of small dimensions a high-efficiency antenna is obtained. It is thus not necessary to use more complex or more costly packages.

The device 1 can thus communicate via radio with other devices 1 that have also been thrown down thus creating an array of devices that extends within a certain territory, for example delimiting it.

Approach of persons and/or vehicles to the array can hence be detected by the sensors.

The presence of a high-efficiency antenna optimizes the energy management of the device 1 reducing the global consumption thereof. In fact, the antenna obtained has a radiation diagram closer to the target one as compared to an antenna oriented at an unknown angle with respect to the ground.

The device 1 is thus able to irradiate a signal of its own using a radiation diagram depending upon the type of radiating element 5 used but not upon the orientation of the device 1 with respect to the ground. This fact enables more efficient and effective irradiation in terms of directionality of the antenna.

In particular, in radio applications where the device must be able to receive non-periodicized signals for long periods, months or years, or with low values of power received (for example, −50 . . . −100 dB), the present invention increases the receiving capabilities of the radio without increasing the power dissipated by the device 1.

The above energy saving is particularly important in applications where the power available on the device 1 is limited, or where the life of the device depends upon a non-rechargeable energy source, for example, the batteries 17. In such applications, optimal management of the available energy is a crucial factor for the life of the device itself.

The antenna directivity in reception and transmission optimizes the power transmitted/received in the directions of interest preventing dispersion of energy in non-desired directions or else preventing desired directions from not being reached by radiation.

In addition, the simplicity of production of the device 1 renders it particularly indicated in radio applications where the cost of the final device must be considerably low or where no type of maintenance is envisaged.

Finally, it is clear how modifications and variations may be made to the device described herein, without thereby departing from the sphere of protection of the present invention as defined in the claims.

The radiating elements, for example, could be obtained with antennas of a different type, for example, dipole antennas or else modified Marconi-dipole antennas.

The apparatus is moreover able to determine its own disposition with respect to the ground by means of an electronic circuit (not illustrated), which receives at input the information corresponding to the closed/open logic state of the four switches 24. In particular, in the case (FIG. 2) where the device 1 sets itself in contact with an area of ground that is predominantly horizontal, three arms 9 touch with their own end portions areas (P1, P2 and P3) of a flat resting surface that approximates the ground.

In this case, the switches 24 associated to the arms 9 in contact with the ground will supply an OFF signal, whilst the switch associated to the arm 9 not in contact with the ground (and substantially vertical) will supply an ON signal. By analysing said four signals, it is possible to identify which arms are in contact with the ground and which one is instead vertical and substantially perpendicular to the surface passing through P1, P2 and P3.

In the case instead where all the signals were to be OFF it may be concluded that none of the arms 9 is substantially perpendicular to the surface on which the device 1 is resting, whereas in the case where all the signals were to be ON it may be concluded that there is a malfunctioning of the switches 24.

In the case of use of a sensor 22 of a magnetic type, the information regarding the orientation with respect to the ground S of the device 1 enables a more correct interpretation of the information regarding the magnetic field measured by the sensor 22.

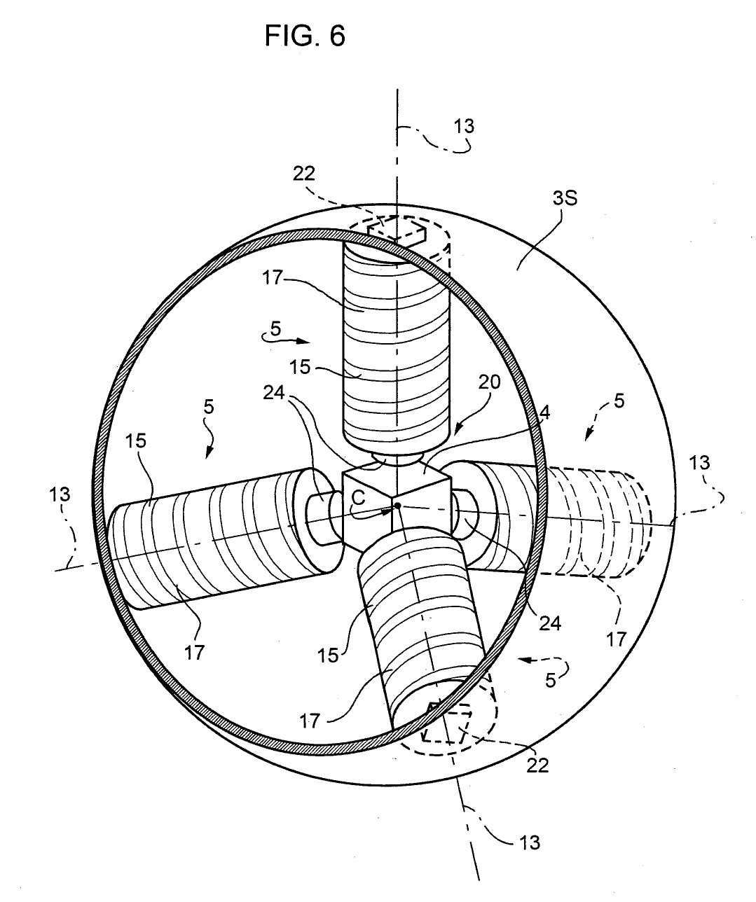

FIG. 6 illustrates a variant of the device 1 shown in the previous figures.

According to said variant, the protective casing 3 assumes a spherical shape 3s and defines an internal cavity, which houses the same components previously described set in the same spatial arrangement with respect to one another.

In particular, the casing 3s houses:
the electronic circuit 4 set at the centre of the spherical casing;
the four cylindrical batteries 17 set aligned to the respective axes 13;
the four switches 24, each of which is set aligned with a respective axis 13 and is set between the end of a battery 17 and the circuit 4;
the sensors 22; and
the four radiating elements 5 having axes of symmetry coinciding with the axes 13.

The means for supporting the various component parts are not illustrated in order to simplify the graphical representation.

Unlike the embodiment described previously, the protective casing 3s does not set itself, on account of its conformation, in a pre-set position with respect to the surface on which the casing 1s is resting.

However, always present is the automatic-selection device 20 for selecting the radiating element 5, which is designed to select for transmission the radiating element 5 that has a pre-set arrangement (in particular, it is substantially parallel to the vertical and/or substantially perpendicular to the resting surface).

1. A radio device for a wireless network comprising:
an outer protective casing housing an electronic transceiver circuit;
at least one first radiating element and one second radiating element, which are carried by said protective casing and have orientations that differ from one another,
said radio device for a wireless network being characterized in that it comprises means for automatic selection of the radiating element set with a pre-set orientation with respect to a resting surface on which said casing is set.

2. The device according to claim 1, wherein said outer protective casing is configured in such a way that, when it is set on a plane resting surface, it sets itself with one radiating element substantially perpendicular to the plane surface;
said automatic-selection means selecting the radiating element set substantially perpendicular to the plane surface.

3. The device according to claim 2, wherein said outer protective casing is configured in such a way that, when it is set on said plane surface, it sets itself with just one radiating element substantially perpendicular to the plane surface.

4. The device according to claim 2, wherein said outer protective casing comprises a central portion and a plurality of arms that extend radially from said central portion.

5. The device according to claim 4, wherein each radiating element is carried by a respective arm.

6. The device according to claim 4, wherein each radiating element is set on the outer surface of said arm.

7. The device according to claim 5, wherein each radiating element is made from a metal strip wound on an outer surface of each arm.

8. The device according to claim 4, wherein said arms have the same length measured in a radial direction with respect to said central portion.

9. The device according to claim 4, wherein four arms are provided, each of which is associated to a respective radiating element.

10. The device according to claim 4, wherein each arm extends along a respective axis; said axes meeting up in a central point of said central portion.

11. The device according to claim 4, wherein said arms have the shape of a truncated cone.

12. The device according claim 4, wherein each arm is tapered from the central portion towards a free end portion thereof.

13. The device according to claim 4, wherein a plurality of batteries are provided for supply of said electronic circuit; each battery being housed in a respective arm.

14. The device according to claim 13, wherein each battery has an elongated shape and extends along a respective axis; the axes of the batteries meeting at the centre of said central portion in such a way that said batteries have a spatial arrangement symmetrical with respect to said central portion.

15. The device according to claim 4, wherein a plurality of sensors are provided, operating with said electronic circuit; each sensor being housed in an end portion of a respective arm.

16. The device according to claim 4, wherein said electronic transceiver circuit is housed in said central portion.

17. The device according to claim 4, wherein said central portion has spherical shape.

18. The device according to claim 1, wherein said selection means comprise a plurality of switches.

19. The device according to claim 1, wherein said selections means selection comprise switch means configured for switching, by gravity, on the basis of their orientation with respect to the vertical.

20. The device according to claim 19, wherein said switch means comprise a first switch and a second switch which are simultaneously set in the closed state (ON) or else open state (OFF) on the basis of their disposition with respect to the vertical;
said first switch, when closed, providing a connection between said radiating element set perpendicular and said electronic transceiver circuit;
said second switch, when closed, providing a connection between a sensor and said electronic transceiver circuit.

21. The device according to claim 19, wherein electronic means are provided, which receive at input the information on the closed/open logic state of said switch means for determining the position of the device with respect to said resting surface.

22. The device according to claim 1, wherein said body comprises a plurality of arms that extend along respective axes of symmetry; said axes meeting up in a common point and forming with respect to one another equal angles.

23. The device according to claim 1, wherein said radiating elements extend along respective geometrical axes; said geometrical axes meeting in a common point and forming with respect to one another equal angles.

24. The device according to claim 1, wherein each radiating element comprises an antenna with helical structure.

25. The device according to claim 1, wherein each radiating element comprises a dipole antenna.

26. The device according to claim 1, wherein each radiating element comprises a modified Marconi-dipole antenna.

27. The device according to claim 1, wherein said casing is made of impact-resistant insulating material.

28. The device according to claim 1, wherein said casing is spherical.

29. The device according to claim 28, wherein said spherical casing houses inside it said radiating elements and means for supply of said transceiver circuit.

30. The device according to claim 28, wherein each radiating element extends along a respective axis; said axes meeting up in a central point of said spherical casing.
